(19) United States
(12) Patent Application Publication
(10) Pub. No.: US 2011/0084934 A1
(43) Pub. Date: Apr. 14, 2011

(54) INFORMATION INPUT DEVICE, INFORMATION INPUT METHOD, INFORMATION INPUT/OUTPUT DEVICE, COMPUTER READABLE NON-TRANSITORY RECORDING MEDIUM AND ELECTRONIC UNIT

(75) Inventors: Ryoichi Tsuzaki, Aichi (JP); Tsutomu Harada, Aichi (JP)

(73) Assignee: Sony Corporation, Tokyo (JP)

(21) Appl. No.: 12/898,948

(22) Filed: Oct. 6, 2010

(30) Foreign Application Priority Data
Oct. 13, 2009 (JP) 2009-236517

(51) Int. Cl. G06F 3/045

(52) U.S. Cl. 345/174

(57) ABSTRACT

An information input/output device allowed to detect both of a finger and a palm as a proximity object is provided. An information input device includes: an input panel obtaining a detection signal from a proximity object; and an object information detection section comparing the detection signal from the input panel with a first threshold value and a second threshold value, thereby detecting information of the proximity object, the first threshold value being provided for detecting the proximity object in proximity to a surface of the input panel, and the second threshold value being lower than the first threshold value.

### BACKGROUND OF THE INVENTION

1. Field of the Invention

The present invention relates to an information input device, an information input method, an computer readable non-transitory recording medium, an information input/output device and an electronic unit which input information by contact or proximity of an object.

2. Description of the Related Art

In recent years, the development of touch panels allowed to input information by direct contact of a finger or the like with a display screen of a display has been proceeding. The touch panels include an optical type touch panel which optically detects a finger or the like, and so on in addition to a contact type touch panel which detects a position of a touched electrode, a capacitive type touch panel using a change in capacitance. For example, in the optical type touch panel, an object in proximity to a display screen is irradiated with image display light or the like, and the presence or absence of a proximity object or the position of the proximity object is detected based on light reflected from the object as described in, for example, Japanese Unexamined Patent Application Publication No. 2008-146165.

### SUMMARY OF THE INVENTION

In the above-described touch panel, as a technique of obtaining position information of a proximity object, reflected light from the proximity object is received by a photo-detection element to obtain a photo-detection signal, and then a binarization process with respect to a predetermined threshold value is performed on the photo-detection signal to generate a picked-up image. However, in this technique, in the case where the proximity object is a palm, it is difficult to detect the proximity object because of the following reason.

Compared to the surface of a finger, the surface of a palm has a wider area and a larger number of asperities, so reflectivity of the surface is not uniform. Therefore, it is more likely to detect, as an image, only a local part of a palm than a whole palm. Such a picked-up image of a palm resembles a picked-up image of a finger, specifically a picked-up image in the case where a plurality of fingers come in proximity to a panel, and it is difficult to distinguish between them.

On the other hand, in the touch panel, there is a desire to execute different processes in response to input by a finger and input by a palm, respectively, or a desire to execute a process only in response to input by a finger (a desire not to activate the touch panel in response to input by a palm). In the case where, as described above, it is difficult to detect a palm in spite of such a desire, a malfunction in processing occurs. Therefore, it is desired to achieve a touch panel allowed to detect not only a finger but also a palm as a proximity object.

It is desirable to provide an information input device, an information input method, an information input/output device, an computer readable non-transitory recording medium and an electronic unit which are allowed to detect both of a finger and a palm as a proximity object.

According to an embodiment of the invention, there is provided an information input device including: an input panel obtaining a detection signal from a proximity object; and an object information detection section comparing the detection signal from the input panel with a first threshold value and a second threshold value, thereby detecting information of the proximity object, the first threshold value being provided for detecting the proximity object in proximity to a surface of the input panel, and the second threshold value being lower than the first threshold value. Note that “proximity object” herein means not only an object literally “in proximity” but also an object “in contact”.

According to an embodiment of the invention, there is provided an information input method including steps of: obtaining a detection signal from a proximity object with use of an input panel; and comparing the detection signal obtained from the input panel with a first threshold value and a second threshold value, thereby detecting information of the proximity object, the first threshold value being provided for detecting the proximity object in proximity to a surface of the input panel, and the second threshold value being lower than the first threshold value.

According to an embodiment of the invention, there is provided an information input/output device including: an input/output panel obtaining a detection signal from a proximity object and displaying an image; and an object information detection section comparing the detection signal obtained by the input/output panel with a first threshold value and a second threshold value, thereby detecting information of the proximity object, the first threshold value being provided for detecting the proximity object in proximity to a surface of the input/output panel, and the second threshold value being lower than the first threshold value.

According to an embodiment of the invention, there is provided a computer readable non-transitory recording medium on which an information input program is recorded, the information input program allowing a computer to execute steps of: obtaining a detection signal from a proximity object with use of an input panel; and comparing the detection signal obtained from the input panel with a first threshold value and a second threshold value, thereby detecting information of the proximity object, the first threshold value being provided for detecting the proximity object in proximity to a surface of the input panel, and the second threshold value being lower than the first threshold value.

According to an embodiment of the invention, there is provided an electronic unit including the above-described information input device according to the embodiment of the invention.

In the information input device, the information input method, the information input/output device, the computer readable non-transitory recording medium and the electronic unit according to the embodiment of the invention, the detection signal from the proximity object is compared with the first threshold value provided for detecting a proximity object in proximity to a panel surface and the second threshold value being lower than the first threshold value, thereby to obtain information of the proximity object. For example, in the case where the proximity object is a finger, information about the presence or absence of proximity of the proximity object, the position of the proximity object or the like is obtained by the comparison process with respect to the first threshold value. On the other hand, in the comparison process with respect to the second threshold value being lower than the first threshold value, information about whether or not the proximity object is a palm, that is, the presence or absence of proximity of a palm is obtained.

In the information input device, the information input method, the information input/output device, the computer readable non-transitory recording medium and the electronic unit according to the embodiment of the invention, the detection signal from the proximity object is compared with the first threshold value and the second threshold value, thereby to obtain information of the proximity object. At this time, a comparison process with respect to the first threshold value for detecting a proximity object in proximity to a panel surface and a comparison process with respect to the second threshold value being lower than the first threshold value are performed, so the presence or absence of proximity of not only a finger but also a palm is detectable. Therefore, both of a finger and a palm are detectable as the proximity object.

Other and further objects, features and advantages of the invention will appear more fully from the following description.

### BRIEF DESCRIPTION OF THE DRAWINGS

FIG. 1 is a block diagram illustrating a configuration of an information input/output device according to an embodiment of the invention.

FIG. 2 is a block diagram illustrating a specific configuration of an input/output panel in FIG. 1.

FIG. 3 is an enlarged sectional view of a part of the input/output panel.

FIG. 4 is a flow chart illustrating an example of an object detection process in the information input/output device.

FIG. 5 is a flow chart illustrating an example of an object detection process according to a comparative example.

FIGS. 6A, 6B and 6C are diagrams illustrating photo-detection signals and binarized picked-up images (the comparative example) in proximity object patterns, that is, in the cases where a proximity object is a finger (single), a palm, and fingers (multiple), respectively.

FIGS. 7A, 7B and 7C are diagrams illustrating photo-detection signals and binarized picked-up images (an example) in proximity object patterns, that is, in the cases where a proximity object is a finger (single), a palm and fingers (multiple), respectively.

FIG. 8 is a flow chart illustrating an object detection process according to Modification 1.

FIG. 9 is a block diagram illustrating a configuration of an information input/output device according to Modification 2.

FIG. 10 is an external perspective view of Application Example 1 of the information input/output device according to the embodiment or the like of the invention.

FIGS. 11A and 11B are an external perspective view from the front side of Application Example 2 and an external perspective view from the back side of Application Example 2, respectively.

FIG. 12 is an external perspective view of Application Example 3.

FIG. 13 is an external perspective view of Application Example 4.

FIGS. 14A to 14G illustrate Application Example 5, where FIGS. 14A and 14B are a front view and a side view in a state in which Application Example 5 is opened, respectively, and FIGS. 14C, 14D, 14E, 14F and 14G are a front view, a left side view, a right side view, a top view and a bottom view in a state in which Application Example 5 is closed, respectively.

### DETAILED DESCRIPTION OF THE PREFERRED EMBODIMENTS

A preferred embodiment will be described in detail below referring to the accompanying drawings. Descriptions will be given in the following order.

1. Embodiment (Example of information input process in which an object is detected with respect to two threshold values for finger detection and palm detection)
2. Modification 1 (Another example of object information detection process)
3. Modification 2 (Another example of information input device)
4. Application Examples 1 to 5 (Application examples to electronic units)

### Embodiment

### Whole Configuration of Information Input/Output Device 1

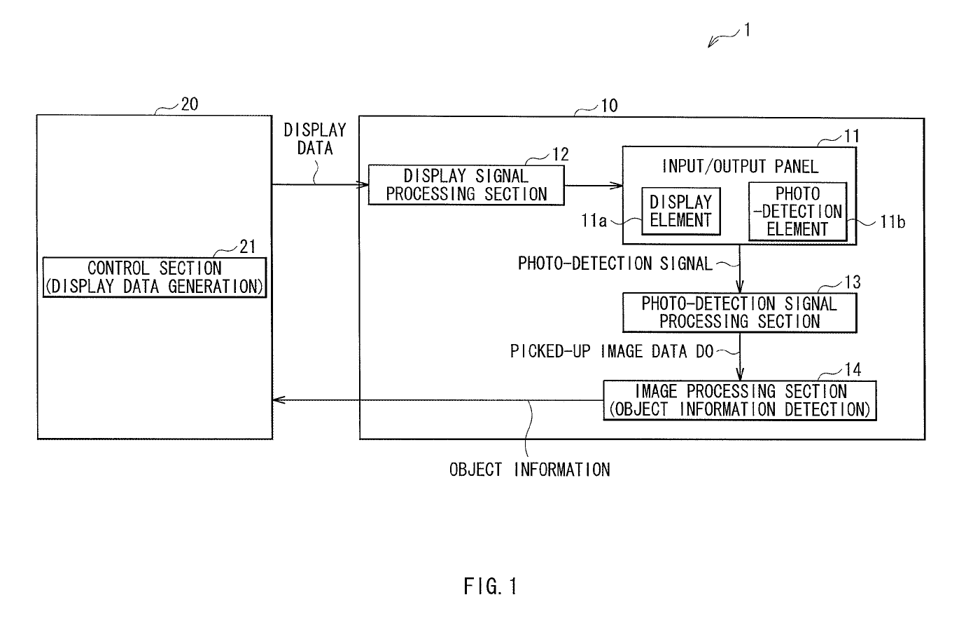

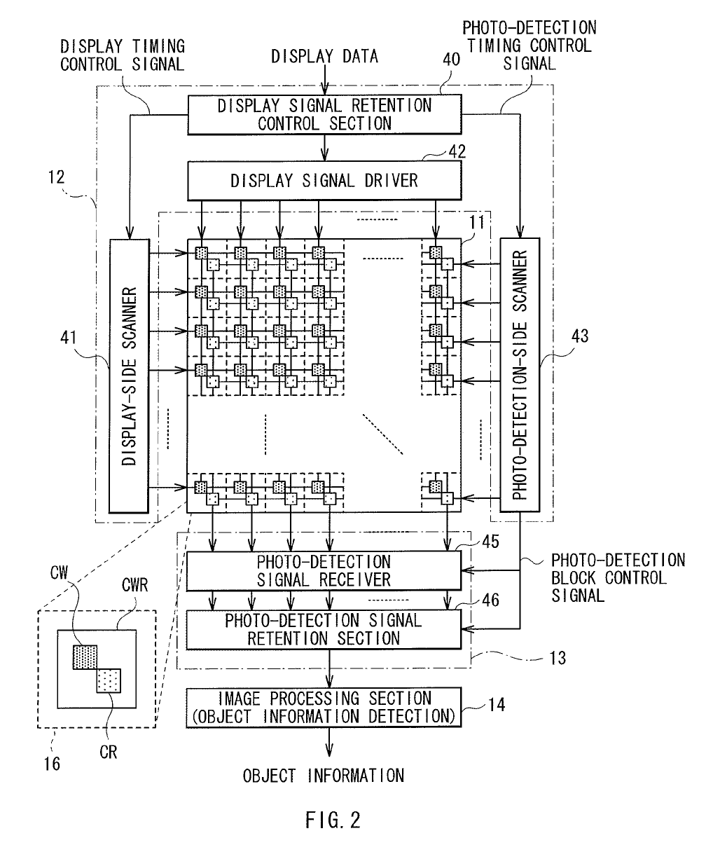

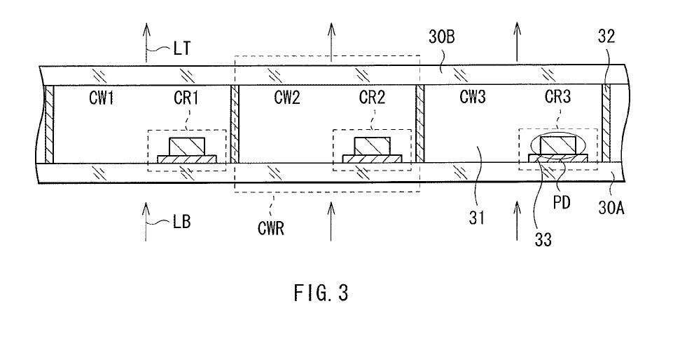

FIG. 1 illustrates a schematic configuration of an information input/output device (an information input/output device 1) according to an embodiment of the invention. FIG. 2 illustrates a specific configuration of a display 10, and FIG. 3 illustrates an enlarged sectional view of a part of an input/output panel 11. The information input/output device 1 is a display having a function of inputting information with use of a finger, a stylus or the like, that is, a so-called touch panel function. The information input/output device 1 includes the display 10 and an electronic device body 20 using the display 10. The display 10 includes the input/output panel 11, a display signal processing section 12, a photo-detection signal processing section 13 and an image processing section 14, and the electronic device body 20 includes a control section 21. An information input method and an computer readable non-transitory recording medium according to an embodiment of the invention are embodied in the information input/output device 1 according to the embodiment, and will not be described.

Input/Output Panel 11

For example, as illustrated in FIG. 2, the input/output panel 11 is a liquid crystal display panel in which a plurality of pixels 16 are arranged in a matrix form, and each of the pixels 16 includes a display element 11a (a display cell CW) and a photo-detection element 11b (a photo-detection cell CR). The display element 11a is a liquid crystal element for displaying an image with use of light emitted from a backlight (not illustrated). The photo-detection element 11b is, for example, a photo-detection element, such as a photodiode, outputting an electrical signal in response to reception of light. In this case, the photo-detection element 11b receives light reflected back from an object in proximity to a panel to the inside of the panel, and outputs a photo-detection signal (a detection signal). In each of the pixels 16, one photo-detection cell CR may be arranged so as to be allocated to one display cell CW or a plurality of display cells CW.

The input/output panel 11 includes, for example, a plurality of following display/photo-detection cells CWR as a plurality of pixels 16. More specifically, as illustrated in FIG. 3, the plurality of display/photo-detection cells CWR are configured by including a liquid crystal layer 31 between a pair of transparent substrates 30A and 30B, and the plurality of display/photo-detection cells CWR are separated from one another by barrier ribs 32. A photo-detection element PD is arranged in a part of each display/photo-detection cell CWR, and a region corresponding to the photo-detection element PD of each display/photo-detection cell CWR is a photo-detection cell CR (CR1, CR2, CR3, . . . ), and the other region of each display/photo-detection cell CWR is a display cell CW (CW1, CW2, CW3, . . . ). In the photo-detection cell CR, to prevent entry of light LB emitted from the backlight, a light-shielding layer 33 is arranged between the transparent substrate 30A and the photo-detection element PD. Therefore, in each photo-detection element PD, only light entering from the transparent substrate 30A (reflected light from a proximity object) is detected without influence of backlight light LB. Such an input/output panel 11 is connected to a display signal processing section 12 arranged preceding thereto and a photo-detection signal processing section 13 arranged subsequent thereto.

Display Signal Processing Section 12

The display signal processing section 12 is a circuit driving the input/output panel 11 to perform an image display operation and a light reception operation based on display data, and includes, for example, a display signal retention control section 40, a display-side scanner 41, a display signal driver 42 and a photo-detection-side scanner 43 (refer to FIG. 2). The display signal retention control section 40 stores and retains a display signal outputted from a display signal generation section (not illustrated) in, for example, a field memory such as an SRAM (Static Random Access Memory), and controls operations of the display-side scanner 41, the display signal driver 42 and the photo-detection-side scanner 43. More specifically, the display signal retention control section 40 outputs a display timing control signal and a photo-detection timing control signal to the display-side scanner 41 and the photo-detection-side scanner 43, respectively, and outputs, to the display signal driver 42, display signals for one horizontal line based on the display signal retained in the field memory. Therefore, in the input/output panel 11, a line-sequential display operation and a photo-detection operation are performed.

The display-side scanner 41 has a function of selecting a display cell CW to be driven in response to the display timing control signal outputted from the display signal retention control section 40. More specifically, a display selection signal is supplied through a display gate line connected to each pixel 16 of the input/output panel 11 to control a display element selection switch. In other words, when a voltage allowing the display element selection switch of a given pixel 16 to turn on is applied in response to the display selection signal, the given pixel 16 performs a display operation with luminance corresponding to the voltage supplied from the display signal driver 42.

The display signal driver 42 has a function of supplying display data to the display cell CW to be driven in response to the display signals for one horizontal line outputted from the display signal retention control section 40. More specifically, a voltage corresponding to display data is supplied to the pixel 16 selected by the above-described display-side scanner 41 through a data supply line connected to each pixel 16 of the input/output panel 11.

The photo-detection-side scanner 43 has a function of selecting a photo-detection cell CR to be driven in response to a photo-detection timing control signal outputted from the display signal retention control section 40. More specifically, a photo-detection selection signal is supplied through a photo-detection gate line connected to each pixel 16 of the input/output panel 11 to control a photo-detection element selection switch. In other words, as in the case of the operation of the above-described display-side scanner 41, when a voltage allowing the photo-detection element selection switch of a given pixel 16 to turn on is applied in response to the photo-detection selection signal, a photo-detection signal detected from the given pixel 16 is outputted to a photo-detection signal receiver 45. Therefore, for example, light emitted from a given display cell CW as display light is reflected from a proximity object, and the reflected light is allowed to be received and detected in the photo-detection cell CR. Such a photo-detection-side scanner 43 also has a function of supplying a photo-detection block control signal to the photo-detection signal receiver 45 and a photo-detection signal retention section 46 to control a block contributing to a photo-detection operation. In the embodiment, the above-described display gate line and the above-described photo-detection gate line are separately connected to each display/photo-detection cell CWR, so the display-side scanner 41 and the photo-detection-side scanner 43 are operable independently of each other.

Photo-Detection Signal Processing Section 13

The photo-detection signal processing section 13 captures the photo-detection signal from the photo-detection element 11b and performs signal amplification, a filter process, or the like, and includes, for example, the photo-detection signal receiver 45 and the photo-detection signal retention section 46 (refer to FIG. 2).

The photo-detection signal receiver 45 has a function of obtaining photo-detection signals for one horizontal line outputted from each photo-detection cell CR in response to the photo-detection block control signal outputted from the photo-detection-side scanner 43. The photo-detection signals for one horizontal line obtained in the photo-detection signal receiver 45 are outputted to the photo-detection signal retention section 46.

The photo-detection signal retention section 46 stores and retains the photo-detection signals outputted from the photo-detection signal receiver 45 in, for example, a field memory such as an SRAM in response to the photo-detection block control signal outputted from the photo-detection-side scanner 43. Data of the photo-detection signals stored in the photo-detection signal retention section 46 is outputted to the image processing section 14. The photo-detection signal retention section 46 may be configured of a storage element except for a memory, and, for example, the light-receiving signals may be retained as analog data (an electric charge) in a capacitive element.

Image Processing Section 14

The image processing section 14 follows and is connected to the photo-detection signal processing section 13, and is a circuit capturing a picked-up image from the photo-detection signal processing section 13 to perform a process such as binarization, isolated point removal or labeling, thereby detecting information of a proximity object (object information). As will be described in detail later, the object information includes information about whether or not the proximity object is a palm, position information of the proximity object, and the like.

Electronic Device Body 20

The electronic device body 20 outputs display data to the display signal processing section 12 of the display 10, and the above-described object information from the image processing section 14 is inputted into the electronic device body 20. The electronic device body 20 includes a control section 21 configured of, for example, a CPU (Central Processing Unit) or the like. The control section 21 generates display data or changes a display image based on the inputted object information.

Functions and effects of information input/output device 1

1. Image Display Operation, Photo-Detection Operation

When the display data outputted from the electronic device body 20 is inputted into the display signal processing section 12, the display signal processing section 12 drives the input/output panel 11 to perform display and receive light based on the display data. Therefore, in the input/output panel 11, an image is displayed by the display elements 11a (the display cells CW) with use of emitted light from the backlight (not illustrated). On the other hand, in the input/output panel 11, the photo-detection elements 11b (the photo-detection cells CR) are driven to receive light.

In such a state that the image display operation and the photo-detection operation are performed, when an object such as a finger comes in contact with or in proximity to a display screen (an input screen) of the input/output panel 11, a part of light emitted for image display from each of the display elements 11a is reflected from a surface of the proximity object. The reflected light is captured in the input/output panel 11 to be received by the photo-detection element 11b. Therefore, a photo-detection signal of the proximity object is outputted from the photo-detection element 11b. The photo-detection signal processing section 13 performs a process such as amplification on the photo-detection signal to process the photo-detection signal, thereby a picked-up image is generated. The generated picked-up image is outputted to the image processing section 14 as picked-up image data D0.

2. Object Information Detection Process

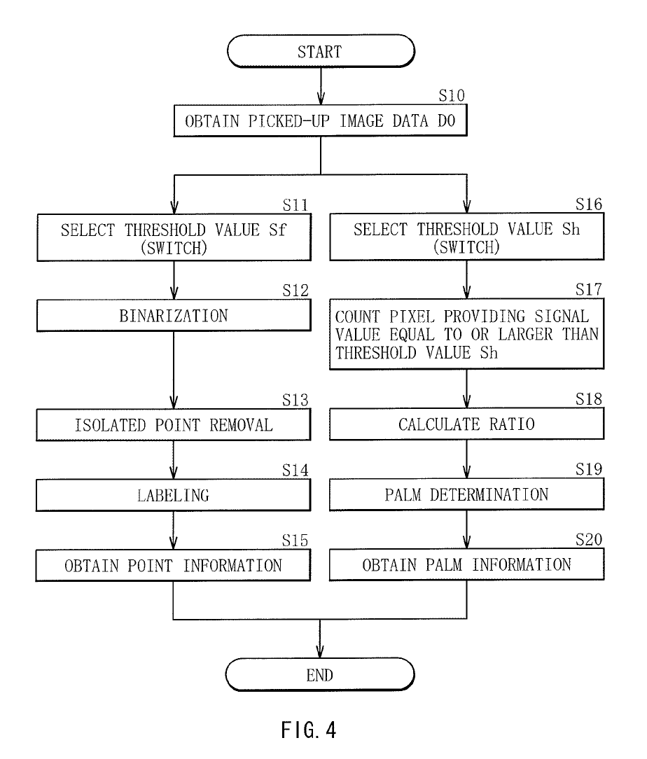

FIG. 4 illustrates a flow of whole image processing (an object information detection process) in the image processing section 14. The image processing section 14 captures the picked-up image data D0 from the photo-detection signal processing section 13 (step S10), and detects object information through a comparison process (such as a binarization process) with respect to a predetermined threshold value on the picked-up image data D0. In the embodiment, the image processing section 14 stores two threshold values Sf and Sh which are preset as the above-described threshold value, and the image processing section 14 captures information (point information) about a detection point such as a finger with respect to the threshold value Sf (a first threshold value) and palm information with respect to the threshold value Sh (a second threshold value). The point information is information about the presence or absence of contact of the proximity object, the position coordinates, area and the like of the proximity object in the case where mainly a finger, a stylus or the like is expected as the proximity object. The palm information is a result of determining whether or not the proximity object is a palm, and more specifically, the palm information indicates either “the proximity object is a palm” or “the proximity object is not palm”. An example of each step for obtaining the point information or the palm information will be described below in comparison with a comparative example.

### Comparative Example

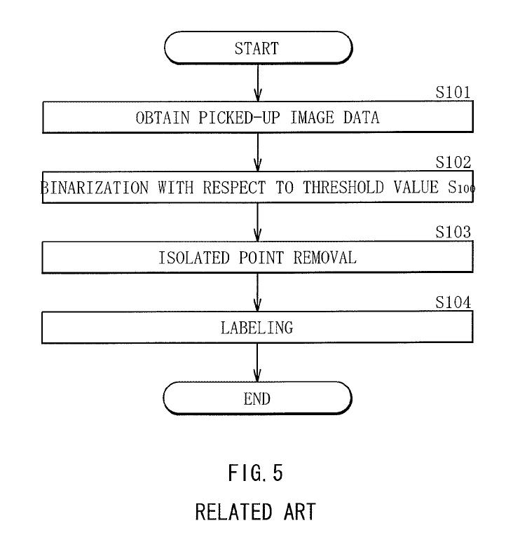

FIG. 5 illustrates a flow of whole image processing (an object information detection process) according to the comparative example. In the comparative example, an image processing section (not illustrated) captures picked-up image data of a proximity object (step S101), and performs a binarization process with respect to a threshold value S₁₀₀ on the picked-up image data (step S102). Next, an isolated point removal process (step S103) and a labeling process (step S104) are executed sequentially to detect object information. In other words, in the comparative example, only one threshold value S₁₀₀ which is preset as a binarization threshold value is stored, and the threshold value S₁₀₀ is uniquely used in object detection. The threshold value S₁₀₀ is, for example, a threshold value set so that an object is detectable in proximity to an input screen.

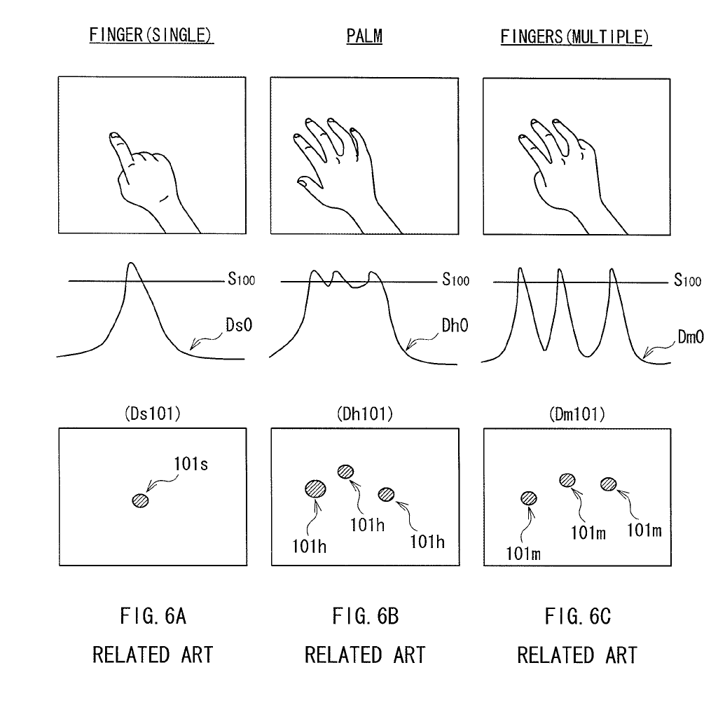

FIGS. 6A to 6C illustrate picked-up image data and binarized picked-up images in proximity object patterns. As the proximity object patterns, the case where the proximity object is one finger (single) (refer to FIG. 6A), the case where the proximity object is a palm (refer to FIG. 6B) and the case where the proximity object is a plurality of fingers (multiple; three fingers in this case) (refer to FIG. 6C) are used.

As illustrated in FIG. 6A, in the case where the proximity object is one finger (for example, an index finger), for example, picked-up image data Ds0 is obtained. When the binarization process with respect to the threshold value S₁₀₀ is performed on the picked-up image data Ds0, a picked-up image Ds101 having one region 101s (corresponding to a aggregate region of “1” which will be described later) is generated as an image of a part where the finger touches. Therefore, in the case where an object to be detected is one finger, desired point information may be obtained with use of the region 101s as a detection point.

As illustrated in FIG. 6B, in the case where the proximity object is a palm, for example, picked-up image data Dh0 is obtained. However, the surface of the palm has a wide area and a large number of asperities, so the reflectivity in a detection plane is not uniform. Therefore, in the picked-up image data Dh0, signal intensity varies depending on a position in the plane (a plurality of intensity peaks are formed). When the binarization process with respect to the same threshold value S₁₀₀ is performed on the picked-up image data Dh0, a picked-up image Dh101 having a plurality of (three in this case) regions 101h (corresponding to aggregate regions of “1” which will be described later) corresponding to variations in signal intensity in the picked-up image data Dh0 is generated. In other words, not the whole palm but only a local part of the palm is detected as an image.

As illustrated in FIG. 6C, in the case where the proximity object is three fingers (for example, an first finger, a second finger and a third finger), for example, picked-up image data Dm0 is obtained. when the binarization process with respect to the threshold value S₁₀₀ is performed on the picked-up image data Dm0, a picked-up image Dm101 having three regions 101m (corresponding to aggregate regions of “1” which will be described later) is generated as an image of respective parts where respective fingers touch.

In other words, the picked-up image Dh101 in the case where the proximity object is a palm and the picked-up image Dm101 in the case where the proximity object is a plurality of fingers which are obtained after the binarization process resemble each other (refer to FIGS. 6B and 6C), and it is difficult to precisely distinguish between them. Therefore, a malfunction in processing may occur in the case where a different process is executed depending on whether an object to be detected is a finger or a palm, in the case where only a finger is an object used to execute a process (a process is halted in the case where the object is a palm), or the like. In particular, in the input/output panel 11, in the case where a so-called multi-touch system in which a plurality of fingers are used to input information is used, it is extremely difficult to prevent a malfunction caused by contact or proximity of a palm.

On the other hand, in the embodiment, as described above, in a comparative process such as a binarization process, two threshold values Sf and Sh are used to obtain the point information and the palm information as will be described below.

2-1. Obtaining Point Information: Steps S11 to S15

The threshold value Sf used for obtaining the point information is a threshold value set so that an object such as a finger or a stylus is detectable in proximity to a surface (an input screen) of the input/output panel 11 as in the case of the threshold value S₁₀₀ in the above-described comparative example. In other words, the threshold value Sf is a threshold value set so that proximity or the like of an object is detectable. In the case where the point information is obtained, the threshold value Sf is selected from the threshold values Sf and Sh (or the threshold value is changed to the threshold value Sf) (step S11), and a binarization process with respect to the threshold value Sf is performed on the picked-up image data D0 (step S12). More specifically, the signal value of each of pixels configuring the picked-up image data D0 is compared with the threshold value Sf, and, for example, when the signal value is lower than the threshold value Sf, data is set to “0”, and when the signal value is equal to or larger than the threshold value Sf, data is set to “1”. Therefore, a part receiving light which is reflected from the proximity object is set to “1”, and the other part is set to “0”.

Next, the image processing section 14 removes an isolated point (noise) from the above-described binarized picked-up image (step S13). In other words, in the binarized picked-up image in the case where the proximity object is present, a aggregate region (corresponding to the proximity object) of parts set to “1” is formed, but in the case where a part set to “1” is isolated from the aggregate region of “1”, a process of removing the isolated part is performed.

Thereafter, the image processing section 14 performs a labeling process on the picked-up image subjected to isolated point removal (step S14). In other words, a labeling process is performed on the aggregate region of “1” in the picked-up image, and the aggregate region of “1” subjected to the labeling process is used as a detection point (a detection region) of the proximity object. The point information of the proximity object is obtained by calculating position coordinates, an area or the like in the detection point (step S15).

2-2. Obtaining Palm Information: Steps S16 to S20

The threshold value Sh used for obtaining the palm information is set to a value lower than the threshold value Sf used for obtaining the point information. In other words, the threshold value Sh is a threshold value set so that an object is detectable at a higher position (a position farther from a panel surface) than a height where the above-described point information is detected. In the case where the palm information is obtained, the threshold value Sh is selected from the threshold values Sf and Sh (or the threshold value is changed to the threshold value Sh) (step S16), and a comparison process with respect to the selected threshold value Sh is performed on the picked-up image data D0. More specifically, the signal value of each of pixels configuring the picked-up image data D0 is compared with the threshold value Sh, and the number of pixels having a signal value equal to or larger than the threshold value Sh is counted (step S17).

Next, the image processing section 14 calculates a ratio of the number of pixels each providing a signal value equal to or larger than the threshold value Sh to the total number of pixels (step S18). Then, whether or not the proximity object is a palm is determined based on the calculated ratio (step S19). More specifically, a ratio (%) represented by “B/A×100” is calculated, where the total number of pixels in the input/output panel 11 is A and the number of pixels each providing a signal value equal to or larger than the threshold value Sh is B, and in the case where the ratio is equal to or larger than a predetermined threshold value (%), it is determined that the proximity object is “a palm”. On the other hand, in the case where the above-described ratio is smaller than the predetermined threshold value, it is determined that the proximity object is “not a palm”. In other words, the palm information including such a determination result is obtained (step S20). In addition, the above-described threshold value used for palm determination may be set according to the size of an effective pixel region (the total number of pixels) in the input/output panel 11. For example, in the case where the electronic device body 20 is a cellular phone or the like having a relatively small display size, the threshold value is set to a value of approximately 40 to 100%.

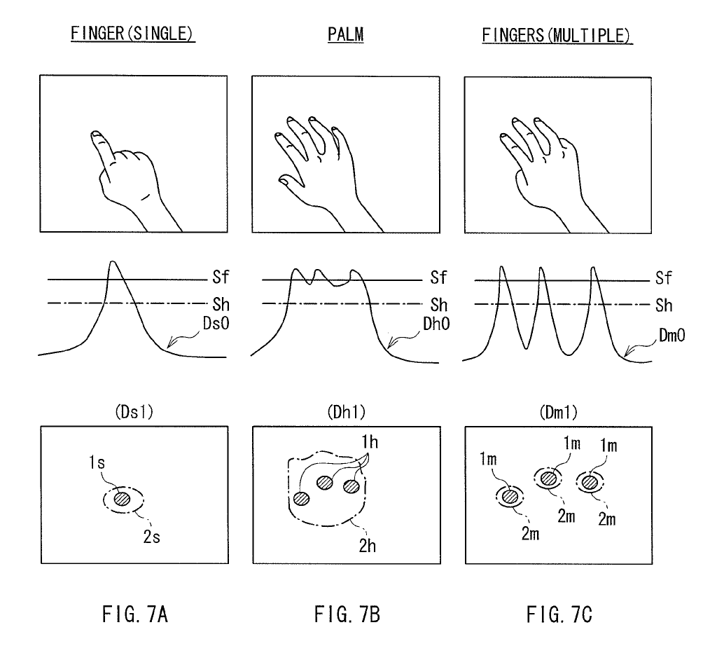

FIGS. 7A to 7C illustrate picked-up image data and binarized picked-up images (hereinafter referred to as binarized images) in proximity object patterns in the embodiment. As in the case of the above-described comparative example, as the proximity object patterns, the case where the proximity object is one finger (single) (refer to FIG. 7A), the case where the proximity object is a palm (refer to FIG. 7B) and the case where the proximity object is a plurality of fingers (multiple: three fingers in this case) (refer to FIG. 7C) are used. In the above-described palm information obtaining step, the binarized image is not generated, and the ratio of the number of pixels is calculated from the picked-up image data D0, but in FIGS. 7A to 7C, binarized images in the case where the threshold value Sh is used are illustrated for comparison.

Case where Point Information is Obtained (Threshold Value Sf)

First, binarized images (picked-up images Ds1 and Dm1) in the case where the threshold value Sf is selected to obtain the point information of the proximity object will be described below. In the picked-up image Ds1 in the case where the proximity object is one finger, for example, one region 1s (corresponding to a aggregate region of “1”) is detected (refer to FIG. 7A), and in the picked-up image Dm1 in the case where the proximity object is three fingers, for example, three regions 1m (corresponding to aggregate regions of “1”) are detected (refer to FIG. 7C). Therefore, after the isolated point removal process and the labeling process, desired point information is obtainable with use of each of the regions 1s and 1m as a detection point. In addition, in the picked-up image Dh1, a region 1h detected in the case where the threshold value Sf is used is also illustrated.

Case where Palm Information is Obtained (Threshold Value Sh)

On the other hand, binarized images (picked-up images Ds1, Dh1 and Dm1) in the case where the threshold value Sh lower than the threshold value Sf is selected to obtain palm information of the proximity object will be described below. In the picked-up image Ds1 in the case where the proximity object is one finger, for example, one region 2s is detected (refer to FIG. 7A), and in the picked-up image Dm1 in the case where the proximity object is three fingers, for example, three regions 2m are detected (refer to FIG. 7C). On the other hand, in the picked-up image Dh1 in the case where the proximity object is a palm, one region 2h corresponding to the whole palm is detected (refer to FIG. 7B). Then, the numbers of pixels corresponding to the regions 2s, 2h and 2m detected in respective patterns are counted, and ratios of the respective numbers of pixels to the total number of pixels in a panel are calculated. When these ratios are compared to a predetermined threshold value, in the picked-up image Dh1 including the region 2h, it is determined that the proximity object is “a palm”, and in the picked-up images Ds1 and Dm1 including the regions 2s and 2m, respectively, it is determined that the proximity object is “not a palm”. In other words, each ratio (a aggregate region of “1” in a binarized image) calculated with respect to the threshold value Sh smaller than the threshold value Sf is relatively large in the case where the proximity object is a palm, and is relatively small in the case where the proximity object is a finger, so whether or not the proximity object is a palm is allowed to be determined.

One of the above-described point information obtaining step (S11 to S15) and the above-described palm information obtaining step (S16 to S20) may be selectively executed by a user (an external input instruction), or both steps may be executed concurrently. For example, in the former case, first, one of a point information detection mode and a palm information detection mode may be selected by the external input instruction or the like so as to execute the above-described step corresponding to the selected mode. On the other hand, in the latter case, the point information obtaining step and the palm information obtaining step may be concurrently executed on the same picked-up image data D0 (picked-up image data in a given field) to obtain both of the point information and the palm information as object information.

As described above, the image processing section 14 obtains one or both of the point information and the palm information as the object information of the proximity object based on the inputted picked-up image data D0, and the obtained object information is outputted to the electronic device body 20. In the electronic device body 20, the control section 21 generates display data based on the object information, and performs a display drive of the input/output panel 11 so as to change an image presently displayed on the input/output panel 11.

As described above, in the embodiment, the comparison process with respect to the threshold value Sf for detecting an object in proximity to the panel surface and the comparison process with respect to the threshold value Sh lower than the threshold value Sf are performed on the picked-up image data D0 of the proximity object. For example, in the case where the proximity object is a finger, point information about the presence or absence of proximity (contact) of the proximity object, position coordinates and the like is obtainable by the binarization process with respect to the threshold value Sf. On the other hand, palm information about whether or not the proximity object is a palm, that is, the presence or absence of proximity (contact) of a palm is obtainable by the comparison process with respect to the threshold value Sh lower than the above-described threshold value Sf (calculation of the ratio of a detection region). Therefore, both of a finger and a palm are detectable as the proximity object.

Therefore, in the input/output panel 11, a malfunction in processing caused by contact or proximity of a palm or the like is preventable in the case where, for example, only a finger or a stylus is an object used to input information (to execute a process), or the like. It is specifically effective in the input/output panel 11 in the case where a so-called multi-touch system, in which a plurality of fingers are used to input information, is used.

In the above-described embodiment, the case where in the palm information obtaining step (S16 to S20), the ratio is calculated directly from the obtained picked-up image data D0 to determine the presence or absence of proximity of a palm is described, but the embodiment is not limited thereto, and as in the case of the above-described point information obtaining step, the binarization process with respect to the threshold value Sh may be performed. Therefore, a detection point (a detection region) of a palm is obtained, and not only the presence or absence of proximity of a palm but also position information and area information of the palm are obtainable. Thus, when point information of not only a finger but also a palm is obtained, different processes may be executed in the case where a finger comes in proximity to the input screen and in the case where a palm comes in proximity to the input screen, respectively.

Next, modifications (Modifications 1 to 2) of the invention will be described below. Hereinafter, like components are denoted by like numerals as of the information input/output device 1 according to the above-described embodiment and will not be further described.

Modification 1

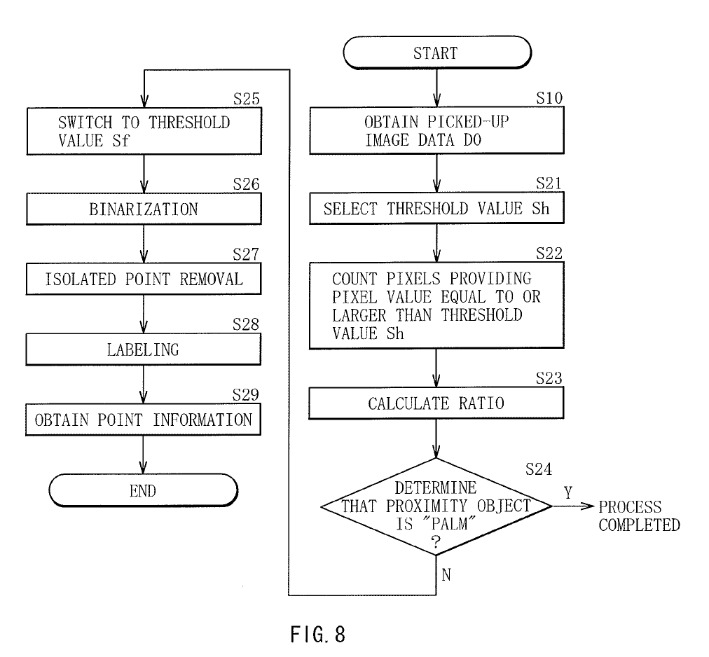

FIG. 8 illustrates a flow of whole image processing (an object information detection process) of an image processing section according to Modification 1. As in the case of the image processing section 14 in the above-described embodiment, the image processing section of the modification is arranged in the display 10 of the information input/output device 1, and obtains the picked-up image data D0 from the photo-detection signal processing section 13 to detect object information, and outputs the detected object information to the electronic device body 20. Moreover, the image processing section stores two threshold values Sf and Sh as threshold values used for object detection, and the threshold value Sf is used to obtain point information such as a finger, and the threshold value Sh is used to obtain palm information.

However, in the modification, unlike the above-described embodiment in which the palm information or the point information is selectively obtained by an external input instruction or the like, or the palm information and the point information are concurrently obtained, point information is obtained after palm determination.

More specifically, when the image processing section of the modification obtains the picked-up image data D0 (from the photo-detection signal processing section 13) (step S10), first, the threshold value Sh is selected from two threshold values Sf and Sh for the picked-up image data D0 (step S21). Then, as in the case of the above-described step S17, the comparison process with respect to the threshold value Sh is performed, and the number of pixels having a pixel value equal to or larger than the threshold value Sh is counted (step S22). Next, as in the case of the above-described step S18, a ratio is calculated (step S23). However, in the modification, whether or not the proximity object is a palm is determined based on the ratio obtained in such a manner (step S24), and in the case where the proximity object is “a palm” (Y in step S24), the processing is completed. On the other hand, in the case where the proximity object is “not a palm” (N in step S24), the processing proceeds to the next step S25.

In the next step S25, switching from the threshold value Sh to the threshold value Sf is performed. Then, as in the case of the above-described steps S12 to S15, a binarization process with respect to the threshold value Sf (step S26), an isolated point removal process (step S27) and a labeling process (step S28) are performed sequentially to obtain point information of the proximity object (step S29).

Thus, in the modification, first, whether or not the proximity object is a palm is determined (palm information is obtained) by the comparison process with respect to the threshold value Sh (calculation of a ratio) on the obtained picked-up image data D0, and in the case where the proximity object is not a palm, the binarization process with respect to the threshold value Sf is performed to obtain point information. In other words, information input by a palm is eliminated irrespective of proximity object patterns (whether the proximity object is a finger or a stylus, or a palm), and only point information of the finger or the stylus is obtainable. Therefore, the same effects as those in the above-described embodiment are obtainable, and in the input/output panel 11, for example, in the case where only a finger or a stylus is used to input information (execute a process), or the like, a malfunction in processing caused by proximity or the like of a palm is preventable more reliably.

Modification 2

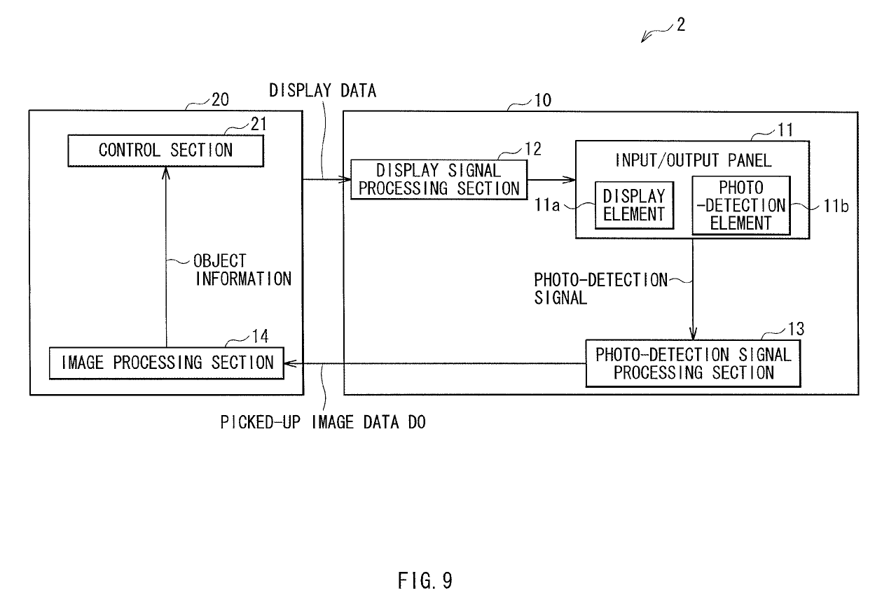

FIG. 9 illustrates a block configuration of an information input/output device 2 according to Modification 2. As in the case of the information input/output device 1 according to the above-described embodiment, the information input/output device 2 includes the display 10 and the electronic device body 20, but the display 10 includes the display signal processing section 12, the input/output panel 11 and the photo-detection signal processing section 13. The electronic device body 20 includes the control section 21 and the image processing section 14. In other words, in the modification, the image processing section 14 is included in not the display 10 but the electronic device body 20. The image processing section 14 may be included in the electronic device body 20 in such a manner, and even in such a case, the same effects as those in the information input/output device 1 according to the above-described embodiment are obtainable.

### Application Examples

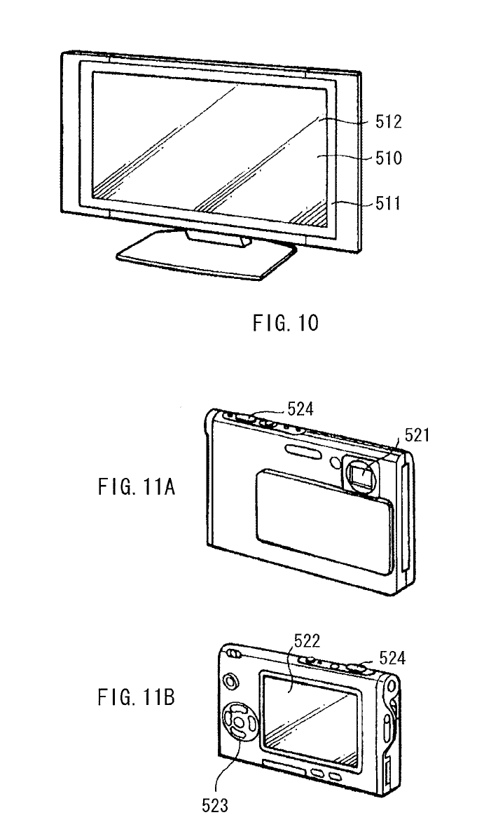

Next, referring to FIG. 10 to FIGS. 14A to 14G, application examples of the information input/output devices described in the above-described embodiment and above-described modifications will be described below. The information input/output devices according to the above-described embodiment and the like are applicable to electronic units in any fields such as televisions, digital cameras, notebook personal computers, portable terminal devices such as cellular phones, and video cameras. In other words, the information input/output devices according to the above-described embodiment and the like are applicable to electronic units displaying a picture signal inputted from outside or a picture signal generated inside as an image or a picture in any fields.

### Application Example 1

FIG. 10 illustrates an appearance of a television. The television has, for example, a picture display screen section 510 including a front panel 511 and a filter glass 512. The picture display screen section 510 is configured of the information input/output device according to any of the above-described embodiment and the like.

### Application Example 2

FIGS. 11A and 11B illustrate appearances of a digital camera. The digital camera has, for example, a light-emitting section 521 for a flash, a display section 522, a menu switch 523, and a shutter button 524. The display section 522 is configured of the information input/output device according to any of the above-described embodiment and the like.

### Application Example 3

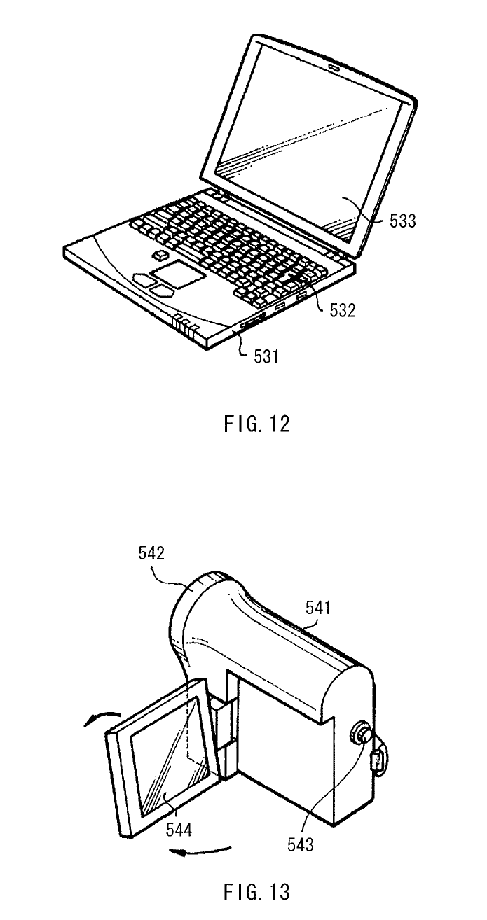

FIG. 12 illustrates an appearance of a notebook personal computer. The notebook personal computer has, for example, a main body 531, a keyboard 532 for operation of inputting characters and the like, and a display section 533 for displaying an image. The display section 533 is configured of the information input/output device according to any of the above-described embodiment and the like.

### Application Example 4

FIG. 13 illustrates an appearance of a video camera. The video camera has, for example, a main body 541, a lens for shooting an object 542 arranged on a front surface of the main body 541, a shooting start/stop switch 543, and a display section 544. The display section 544 is configured of the information input/output device according to any of the above-described embodiment and the like.

### Application Example 5

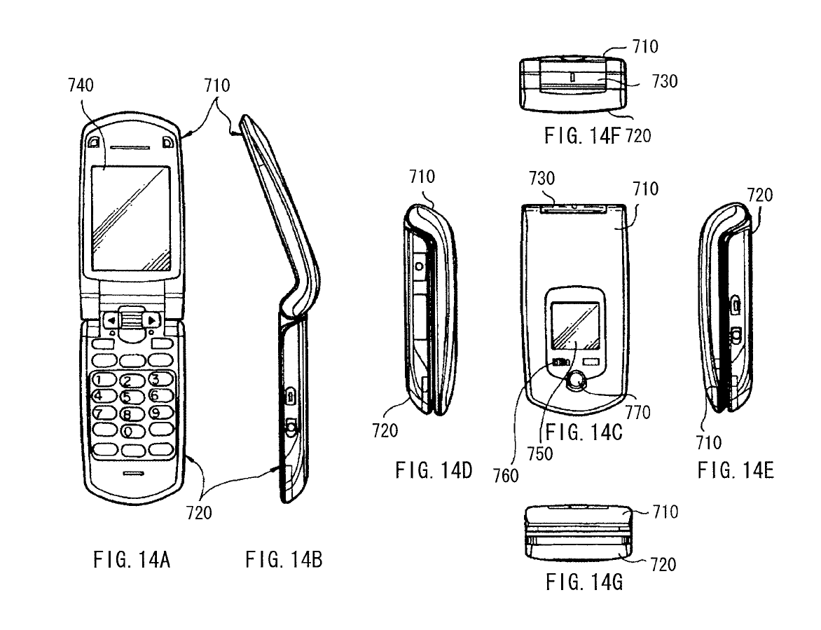

FIGS. 14A to 14G illustrate appearances of a cellular phone. The cellular phone is formed by connecting, for example, a top-side enclosure 710 and a bottom-side enclosure 720 to each other by a connection section (hinge section) 730. The cellular phone has a display 740, a sub-display 750, a picture light 760, and a camera 770. The display 740 or the sub-display 750 is configured of the information input/output device according to any of the above-described embodiment and the like.

Although the present invention is described referring to the embodiment, the modifications and the application examples, the invention is not limited thereto, and may be variously modified. For example, in the above-described embodiment and the like, as an object detection system, an optical system in which detection is performed with use of reflected light from the proximity object by the photo-detection elements 11b arranged in the input/output panel 11 is described as an example, but any other detection system, for example, a contact system, a capacitive system or the like may be used.

Moreover, in the above-described embodiment and the like, the case where the control section 21 is arranged in the electronic device body 20 is described, but the control section 21 may be arranged in the display 10.

Further, in the above-described embodiment and the like, the information input/output device with an input/output panel having both of a display function and a detection function (a photo-detection function) is described as an example, but the invention is not limited thereto. For example, the invention is applicable to an information input/output device configured of a display with an external touch sensor.

In addition, in the above-described embodiment and the like, the case where the liquid crystal display panel is used as the input/output panel is described as an example, but the invention is not limited thereto, and an organic electroluminescence (EL) panel or the like may be used as the input/output panel. In the case where the organic EL panel is used as the input/output panel, for example, a plurality of organic EL elements may be arranged on a substrate as display elements, and one photodiode as a photo-detection element may be arranged so as to be allocated to each of the organic EL elements or two or more organic EL elements. Moreover, the organic EL element has characteristics of, when a forward bias voltage is applied, emitting light, and, when a backward bias voltage is applied, receiving light to generate a current. Therefore, when such characteristics of the organic EL element are used, even if the photo-detection element such as a photodiode is not arranged separately, an input/output panel having both of the display function and the detection function is achievable.

Moreover, in the above-described embodiment and the like, the invention is described referring to the information input/output device with the input/output panel having a display function and a detection function (a display element and a photo-detection element) as an example, but the invention does not necessarily have a display function (a display element). In other words, the invention is applicable to an information input device (an image pickup device) with an input panel having only a detection function (a photo-detection element). Further, such an input panel and an output panel (a display panel) having a display function may be arranged separately.

The processes described in the above-described embodiment and the like may be performed by hardware or software. In the case where the processes are performed by software, a program forming the software is installed in a general-purpose computer or the like. Such a program may be stored in a recording medium mounted in the computer in advance.

The present application contains subject matter related to that disclosed in Japanese Priority Patent Application JP 2009-236517 filed in the Japan Patent Office on Oct. 13, 2009, the entire content of which is hereby incorporated by references.

It should be understood by those skilled in the art that various modifications, combinations, sub-combinations and alterations may occur depending on design requirements and other factors insofar as they are within the scope of the appended claims or the equivalents thereof.

What is claimed is:

1. An information input device comprising:
an input panel obtaining a detection signal from a proximity object; and
an object information detection section comparing the detection signal from the input panel with a first threshold value and a second threshold value, thereby detecting information of the proximity object, the first threshold value being provided for detecting the proximity object in proximity to a surface of the input panel, and the second threshold value being lower than the first threshold value.

2. The information input device according to claim 1, wherein
the object information detection section is configured so that the proximity object is detectable as a first type of detection object or a second type of detection object,
the first type of detection object is detected with respect to the first threshold value, and
the second type of detection object is detected with respect to the second threshold value or both of the first and the second threshold values.

3. The information input device according to claim 2, wherein
the input panel includes a plurality of detection elements, and
the object information detection section determines a ratio, in number, of detection elements each providing signal values larger than the second threshold value to all of the detection elements in the input panel through a comparison process with respect to the second threshold value, and determines, based on the ratio, whether or not the proximity object is the second type of detection object.

4. The information input device according to claim 3, wherein
the information input device is configured to selectively execute a predetermined processing operation based on information inputted with the proximity object, whereas, when the proximity object is judged to be the second type of detection object by the object information detection section, the processing operation is halted.

5. The information input device according to claim 3, wherein
the object information detection section concurrently performs a comparison process with respect to the first threshold value and the comparison process with respect to the second threshold value, and
the object information detection section binarizes the detection signal with respect to the first threshold value in the comparison process with respect to the first threshold value, thereby to generate a binarized image, and then obtains position information of the proximity object based on the binarized image.

6. The information input device according to claim 3, wherein
the object information detection section performs a comparison process with respect to the first threshold value, when the proximity object is judged to be other than the second type of detection object in the comparison process with respect to the second threshold value, and
the object information detection section binarizes the detection signal with respect to the first threshold value in the comparison process with respect to the first threshold value, thereby to generate a binarized image, and then obtains position information of the proximity object based on the binarized image.

7. The information input device according to claim 2, wherein
the object information detection section determines a ratio, in area, of a detection region providing a signal value larger than the second threshold value to an entire detection region in the input panel, and determines, based on the ratio, whether or not the proximity object is the second type of detection object.

8. The information input device according to claim 7, wherein
the information input device is configured to selectively execute a predetermined processing operation based on information inputted with the proximity object, whereas, when the proximity object is judged to be the second type of detection object by the object information detection section, the processing operation is halted.

9. The information input device according to claim 7, wherein
the object information detection section binarizes the detection signal with respect to the first threshold value in a comparison process with respect to the first threshold value, thereby to generate a first binarized image, and binarizes the detection signal with respect to the second threshold value in a comparison process with respect to the second threshold value, thereby to generate a second binarized image, and then obtains position information of the proximity object based on the first and second binarized images.

10. The information input device according to claim 9, wherein
the object information detection section determines, based on the first and second binarized images, whether each of a plurality of proximity objects is the first type of detection object or the second type of detection object.

11. The information input device according to claim 1 wherein
the detection signal is a photo-detection signal based on light reflected from the proximity object.

12. An information input method comprising steps of:
obtaining a detection signal from a proximity object with use of an input panel; and
comparing the detection signal obtained from the input panel with a first threshold value and a second threshold value, thereby detecting information of the proximity object, the first threshold value being provided for detecting the proximity object in proximity to a surface of the input panel, and the second threshold value being lower than the first threshold value.

13. An information input/output device comprising:
an input/output panel obtaining a detection signal from a proximity object and displaying an image; and
an object information detection section comparing the detection signal obtained by the input/output panel with a first threshold value and a second threshold value, thereby detecting information of the proximity object, the first threshold value being provided for detecting the proximity object in proximity to a surface of the input/output panel, and the second threshold value being lower than the first threshold value.

14. The information input/output device according to claim 13, wherein the input/output panel includes:
a plurality of display elements displaying an image based on image data, and
a plurality of photo-detection elements detecting light reflected from the proximity object.

15. A computer readable non-transitory recording medium on which an information input program is recorded, the information input program allowing a computer to execute steps of:
obtaining a detection signal from a proximity object with use of an input panel; and
comparing the detection signal obtained from the input panel with a first threshold value and a second threshold value, thereby detecting information of the proximity object, the first threshold value being provided for detecting the proximity object in proximity to a surface of the input panel, and the second threshold value being lower than the first threshold value.

16. An electronic unit having an information input device, the information input device comprising:
an input panel obtaining a detection signal from a proximity object; and
an object information detection section comparing the detection signal obtained by the input panel with a first threshold value and a second threshold value, thereby detecting information of the proximity object, the first threshold value being provided for detecting the proximity object in proximity to a surface of the input panel, and the second threshold value being lower than the first threshold value.
